(19) United States
(12) Patent Application Publication
(10) Pub. No.: US 2025/0219827 A1
(43) Pub. Date: Jul. 3, 2025

(54) SELF-REVOCATION OF A TRUSTED COMPONENT NODE

(71) Applicant: Telefonaktiebolaget LM Ericsson (PUBL), Stockholm (SE)

(72) Inventors: Gianluca SCOPELLITI, Beverlee (BE); Christoph BAUMANN, Bromma (SE)

(21) Appl. No.: 18/875,554

(22) PCT Filed: Jun. 22, 2022
(86) PCT No.: PCT/SE2022/050624

§ 371 Date: Dec. 16, 2024

(51) Int. Cl. H04L 9/08; H04L 9/32; H04L 43/106

(52) U.S. Cl. CPC H04L 9/0891; H04L 9/3297; H04L 43/106

(57) ABSTRACT

There is provided techniques for self-revocation. A method is performed by a TC node (200a). The TC node (200a) is provided with an identifier and DAA credentials. The TC node (200a) is to receive a heartbeat message from an RA node (300). The heartbeat message comprises a freshness parameter and a revocation request with a list of identifiers for which revocation is pending. The method comprises revoking (S106a, S106b) the DAA credentials when either: the heartbeat message is received from the RA node (300) whilst a counter condition is satisfied, correctness of the freshness parameter is verified by the TC node (200a), and the identifier is present in the list of identifiers; or failing to receive the heartbeat message from the RA node (300) whilst the counter condition is satisfied.

### TECHNICAL FIELD

Embodiments presented herein relate to a method, a trusted component node, a computer program, and a computer program product for self-revocation. Embodiments presented herein further relate to a method, a revocation authority node, a computer program, and a computer program product for sending a heartbeat message for self-revocation.

### BACKGROUND

In general terms, Vehicle-to-everything (V2X) refers to communication between a vehicle and any entity that may affect, or may be affected by, the vehicle. It is a vehicular communication system that incorporates other more specific types of communication as V2I (vehicle-to-infrastructure), V2N (vehicle-to-network), V2V (vehicle-to-vehicle), V2P (vehicle-to-pedestrian), V2D (vehicle-to-device).

V2X applications have stringent performance, security, and privacy requirements. As an example, to fulfil some of these requirements, the vehicles involved in V2X communication exchange authenticated (such as cryptographically signed) messages with each other. In some scenarios each vehicle should be able to verify hundreds to thousands of such messages per second. As a further example, to fulfil some of these requirements, the vehicles can use pseudonyms to hide their real identity and thereby avoid being tracked by other vehicles, or even malicious entities.

Several protocols exist for the attestation and authentication of vehicles in V2X applications. Some of them rely on the classic Public-Key Infrastructure (PKI), which is also the standardized architecture. However, these protocols have some drawbacks, as they were not specifically designed for V2X applications. As a consequence, new protocols have been proposed to provide a more efficient and privacy-preserving authentication/attestation scheme, such as Direct Anonymous Attestation (DAA). DAA relies on a Trusted Component (TC) that leverages technologies such as the Trusted Platform Module (TPM) to provide secure storage of credentials and cryptographic functions. The TC is also used for authenticating the vehicle and retrieving fresh DAA credentials, which are then used to generate pseudonyms and sign/verify messages that are communicated to other vehicles.

Besides verifying signatures of messages between vehicles, protocols used for V2X applications should also enable the participating vehicles to verify that received messages from other participating vehicles are recent and fresh. One purpose of this is to guard against replay attacks as well as other types of attacks. This could be achieved by timestamps being added to messages sent between the vehicles. The time reflected by a timestamp could be represented either by the actual synchronized time between all participating vehicles, or by some unforgeable epoch marker that is distributed regularly by a central entity to all participating vehicles. The latter may be used by the infrastructure to announce a common time period, or epoch, to all participating vehicles, when synchronized real-time time indications are not available. In any case, when a message is created by the TC with a timestamp or epoch marker, the message should be rejected by all other TCs that are correctly synchronized after some time determined by the infrastructure, or configuration, of the TCs.

Another aspect of V2X protocols is revocation, i.e., the possibility to remove compromised, or malicious, vehicles from the network to prevent them from spreading false information. In PKI-based protocols, this is usually achieved by means of certificate revocation lists (CRLs). Another revocation strategy is to use short-lived pseudonyms, so that any attacker would not be able to sign new messages after a pseudonym's life expires. Some DAA protocols, instead, propose a “self-revocation” technique, which leverages the TC to automatically delete DAA credentials and/or pseudonyms upon reception of a request from a revocation authority.

Each of the aforementioned revocation techniques has its own drawbacks.

Revocation lists get bigger and bigger over time, and this is a problem in V2X scenarios since each vehicle can have many pseudonyms. Furthermore, these lists need to be downloaded by each vehicle and used to ensure that a certain pseudonym has not been revoked. For each message to be sent that is signed by the certificate of a certain pseudonym, a verification must be made by checking the downloaded lists to ensure that this certain pseudonym has not been revoked. This slows down the verification process, especially as the lists grow. Besides, updates need to be downloaded periodically to ensure that up-to-date information is used.

Short-lived pseudonyms require vehicles to periodically fetch new pseudonyms from edge servers, or other network-based entities. In case of a compromised vehicle, the vehicle is not automatically removed from the network. Rather, such a vehicle is able to continue sending (malicious) information until the pseudonym expires. Hence, there must be a trade-off between usability and security; the shorter the lifetime is, the lesser the damage an attacker can do, but this requires vehicles to fetch new pseudonyms with higher frequency of occurrence.

Self-revocation is triggered when a revocation request is received by a TC inside a vehicle. However, if this request is dropped (e.g., due to network disruptions and/or attacks) the TC would never receive it, and hence revocation would not be triggered. To deal with this issue, a heartbeat technique has been proposed. Accordingly, keep-alive messages are periodically broadcast to vehicles from a network node; a TC can automatically revoke itself if it does not receive any keep-alive message for some time. This is since the absence of a keep-alive message may be interpreted as a possible ongoing attack. However, although some academic research has been published, see for example Förster, David, et al. “Rewire—revocation without resolution: A privacy-friendly revocation mechanism for vehicular ad-hoc networks,” International Conference on Trust and Trustworthy Computing. Springer, Cham, 2015., and Whitefield, Jorden, et al. “Privacy-enhanced capabilities for VANETs using direct anonymous attestation,” 2017 IEEE Vehicular Networking Conference (VNC), IEEE, 2017, such techniques are yet to be explained in detail and some security concerns arise. In a scenario where a vehicle is fully compromised (except for the TC, which is assumed to be tamper-resistant), targeted attacks might delay or even bypass revocation, which could cause safety damage to other vehicles, pedestrians, or the physical infrastructure.

Since revocation lists for pseudonyms can become infeasible, a combination of short-lived pseudonym certificates and CRLs has been proposed to revoke long-term identities. The CRLs would be used by the different authorities of the system to prevent issuing new pseudonyms to revoked vehicles. Pseudonyms, instead, cannot be revoked: a revoked (and possibly malicious) vehicle could continue its operation until all its pseudonyms expire.

### SUMMARY

An object of embodiments herein is to address at least one of the drawbacks and issues disclosed above in order to enable secures and more timely self-revocation.

According to a first aspect there is presented a method for self-revocation. The method is performed by a TC node. The TC node is provided with an identifier and DAA credentials. The TC node is to receive a heartbeat message from an RA node. The heartbeat message comprises a freshness parameter and a revocation request with a list of identifiers for which revocation is pending. The method comprises revoking the DAA credentials when either: the heartbeat message is received from the RA node whilst a counter condition is satisfied, correctness of the freshness parameter is verified by the TC node, and the identifier is present in the list of identifiers; or failing to receive the heartbeat message from the RA node whilst the counter condition is satisfied.

According to a second aspect there is presented a TC node for self-revocation. The TC node is provided with an identifier and DAA credentials. The TC node is configured to receive a heartbeat message from an RA node. The heartbeat message comprises a freshness parameter and a revocation request with a list of identifiers for which revocation is pending, the TC node comprises processing circuitry. The processing circuitry is configured to cause the TC node to revoke the DAA credentials when either: the heartbeat message is received from the RA node whilst a counter condition is satisfied, when correctness of the freshness parameter is verified by the TC node, and the identifier is present in the list of identifiers; or failing to receive the heartbeat message from the RA node whilst the counter condition is satisfied.

According to a third aspect there is presented a TC node for self-revocation. The TC node is provided with an identifier and DAA credentials. The TC node is configured to receive a heartbeat message from an RA node. The heartbeat message comprises a freshness parameter and a revocation request with a list of identifiers for which revocation is pending. The TC node comprises a revoke module configured to revoke the DAA credentials when either: the heartbeat message is received from the RA node whilst a counter condition is satisfied, when correctness of the freshness parameter is verified by the TC node, and the identifier is present in the list of identifiers; or failing to receive the heartbeat message from the RA node whilst the counter condition is satisfied.

According to a fourth aspect there is presented a computer program for self-revocation, the computer program comprises computer code which is run on processing circuitry of a TC node. The TC node is provided with an identifier and DAA credentials. The TC node is to receive a heartbeat message from an RA node. The heartbeat message comprises a freshness parameter and a revocation request with a list of identifiers for which revocation is pending. The computer program is configured to causes the TC node to revoke the DAA credentials when either: the heartbeat message is received from the RA node whilst a counter condition is satisfied, when correctness of the freshness parameter is verified by the TC node, and the identifier is present in the list of identifiers; or failing to receive the heartbeat message from the RA node whilst the counter condition is satisfied.

According to a fifth aspect there is presented a method for sending a heartbeat message for self-revocation, the method is performed by an RA node. The method comprises sending a heartbeat message towards TC nodes. The heartbeat message comprises a freshness parameter and a revocation request with a list of identifiers of TC nodes for which revocation is pending. The revocation pertains to revocation of identifiers for which the revocation is pending.

According to a sixth aspect there is presented an RA node for sending a heartbeat message for self-revocation. The RA node comprises processing circuitry. The processing circuitry is configured to cause the RA node to send a heartbeat message towards TC nodes. The heartbeat message comprises a freshness parameter and a revocation request with a list of identifiers of TC nodes for which revocation is pending. The revocation pertains to revocation of identifiers for which the revocation is pending.

According to a seventh aspect there is presented an RA node for sending a heartbeat message for self-revocation. The RA node comprises a send module configured to send a heartbeat message towards TC nodes. The heartbeat message comprises a freshness parameter and a revocation request with a list of identifiers of TC nodes for which revocation is pending. The revocation pertains to revocation of identifiers for which the revocation is pending.

According to an eighth aspect there is presented a computer program for sending a heartbeat message for self-revocation. The computer program comprises computer code which, when run on processing circuitry of an RA node, causes the RA node to send a heartbeat message towards TC nodes. The heartbeat message comprises a freshness parameter and a revocation request with a list of identifiers of TC nodes for which revocation is pending. The revocation pertains to revocation of identifiers for which the revocation is pending.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects ensure that self-revocation will always be performed within a fixed time T, or a fixed number of operations N, as given by the counter condition. Attackers can neither delay nor bypass revocation, even considering a powerful attacker that has complete control over a vehicle (except for the TC node).

Advantageously, these aspects do not rely on other revocation techniques such as classic CRLs or short-lived pseudonyms. This brings several advantages in terms of usability, performance and network traffic.

Different advantageous variants are disclosed with respect to how to realize the counter condition, thus enabling adaptability to the scenario and system requirements at hand. For some variants the need for time synchronization is removed. This is advantageous, as it is a very hard requirement to satisfy on compromised vehicles. Furthermore, not all TC nodes can leverage a trusted time source.

Advantageously, parameters based on which the self-revocation is performed are selected by the TC node and the RA node and therefore cannot be controlled by any attacker. The parameters can be tuned according to the system requirements. For example, the higher the worst-case revocation time is selected, the more resilient the system would be to network disruptions, or limited connectivity, but the higher is also the damage an attacker could accomplish in case of compromise.

Advantageously, since classic CRLs lists are not needed, the network traffic would be lower. This reduces the risk of network congestion and also lowers the energy consumption. Further in this respect, unlike classic CRLs, the identifiers provided in the list of identifiers of TC nodes for which revocation is pending do not have to stay inside the list indefinitely but can be removed after the revocation is completed. Hence, although the size of the heartbeat messages might grow large for short periods of time, the size will generally remain rather small.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 10, 17, 18 are flowcharts of methods according to embodiments;

FIGS. 3, 6, 7 are schematic illustrations of interactions between trusted component nodes and a revocation authority node according to embodiments;

FIGS. 4, 5, 8, 9, 11, 12, 13, 14 are sequence diagrams according to embodiments;

FIGS. 15 and 16 schematically illustrate behavior of an attacker and a victim according to embodiments;

FIG. 19 is a schematic diagram showing functional units of a trusted component node according to an embodiment;

FIG. 20 is a schematic diagram showing functional modules of a trusted component node according to an embodiment;

FIG. 21 is a schematic diagram showing functional units of a revocation authority node according to an embodiment;

FIG. 22 is a schematic diagram showing functional modules of a revocation authority node according to an embodiment; and

FIG. 23 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

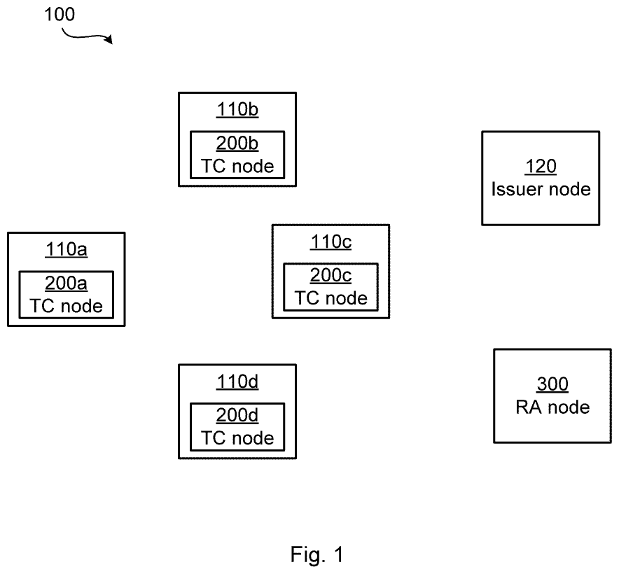

FIG. 1 is a schematic diagram illustrating a communication network 100 where embodiments presented herein can be applied. The communication network 100 comprises TC nodes 200a, 200b, 200c, 200d provided in communication devices 110a, 110b, 110c, 110d. In some non-limiting examples, the communication devices 110a:110d are vehicles equipped for V2X communication. The vehicles could be land vehicles, such as cars, busses, trucks, heavy-duty vehicles, or the like, or sea vehicles, such as ships, boats, submarines, or other type of vessels, or aircraft, such as unmanned aerial vehicles, airplanes, helicopters, or the like.

The first phase for the vehicle 110:110d before being able to communicate with each other is to authenticate themselves to a remote server called an issuer node 120. When using DAA, this step is referred to as executing a JOIN protocol. During this step, the issuer node 120 attests the TC nodes 200a:200d, verifying their authenticity. At the end of this phase, the issuer node 120 generates new DAA credentials that can be used later by a TC nodes 200a:200d to create new pseudonyms and sign/verify messages. The DAA credentials are securely stored and used inside the TC nodes 200a:200d, so that attackers would not be able to directly access them, even in case of vehicle compromise. In general terms, the DAA credentials of a given TC node 200 are credentials that establish the identity of this given TC node 200a when communicating with other TC nodes 200b:200d. The DAA credentials are also used to verify incoming messages from other TC nodes 200b:200d. In some examples, the DAA credentials are machine-readable cryptographic keys and/or passwords. The DAA might be regarded as being part of a group signature scheme, where there are many private keys (one for each TC node 200a:200d) but one single public key that can be used to verify all messages. Hence, the DAA credentials might include both a private key used to sign messages and a group public key used to verify other messages. An X.509 public key certificate is an example of a cryptographic credential.

After authentication, a vehicle 110:110d becomes able to broadcast authenticated messages to other vehicles 110:110d in the same area using pseudonyms. Such pseudonyms can be created using the CREATE protocol. Different designs propose different approaches for the CREATE. For example, vehicles 110a:110d might be allowed to generate new pseudonyms independently, using a sort of derivation function taking as input the DAA credential obtained during the JOIN phase. In other examples, a centralized node is involved in the process of generating new pseudonyms for the vehicles 110a:110d.

Upon reception of a message, a TC node 200a:200d can use its DAA credentials to verify that the message is authentic, i.e., that has been produced by a valid (non-revoked) TC node 200a:200d. DAA uses a group signature scheme where a signature made by any of the participants in the group can be verified by everyone using the same public key.

For illustrative purposes it is assumed that at some point in time, a vehicle 110b might start sending false information to other vehicles, e.g., due to a compromise or a defect. An RA node 300 is responsible for revoking that particular vehicle or pseudonym, for example after a certain number of reports have been received. The revocation can either be “soft” (where the RA node 300 revokes a pseudonym) or “hard” (where the RA node 300 removes an entire vehicle from the network by revoking its DAA credentials and all its pseudonyms). A revocation request is therefore issued by the RA node 300 and received by the involved vehicle 110b, which forwards the information to the TC node 200b inside the vehicle 110b. Then, the TC node 200b proceeds with the deletion of the involved credentials. Only soft revocation is considered in the remainder of this disclosure. To also support hard revocation, it would be sufficient to add information to the revocation request. How the RA node 300 decides whether to perform hard or soft revocation is out of scope for the present disclosure.

The embodiments disclosed herein relate to techniques for self-revocation and sending a heartbeat message for self-revocation that address these issues. In order to obtain such techniques there is provided a TC node 200a, a method performed by the TC node 200a, a computer program product comprising code, for example in the form of a computer program, that when run on processing circuitry of the TC node 200a, causes the TC node 200a to perform the method. In order to obtain such techniques there is further provided an RA node 300, a method performed by the RA node 300, and a computer program product comprising code, for example in the form of a computer program, that when run on processing circuitry of the RA node 300, causes the RA node 300 to perform the method.

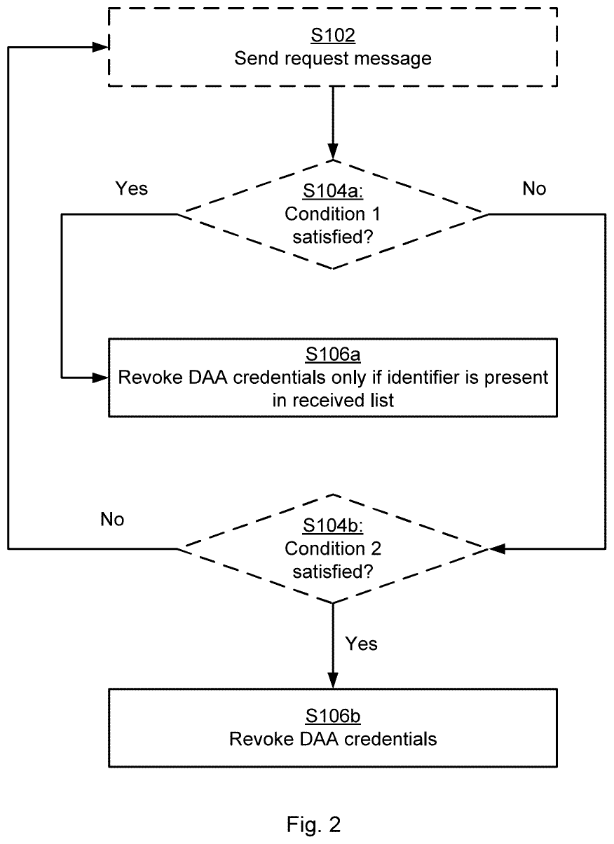

Reference is now made to FIG. 2 illustrating a method for self-revocation as performed by the TC node 200a according to an embodiment. The TC node 200a is provided with an identifier and DAA credentials. The TC node 200a is to receive a heartbeat message from the RA node 300. The heartbeat message comprises a freshness parameter and a revocation request with a list of identifiers for which revocation is pending.

S106a, S106b: The TC node 200a revokes the DAA credentials when either Condition 1 or Condition 2 is fulfilled.

Condition 1 comprises three sub-conditions; (i) the heartbeat message is by the TC node 200a received from the RA node 300 whilst a counter condition is satisfied, (ii) correctness of the freshness parameter can be verified by the TC node 200a, and (iii) the identifier of the TC node 200a is present in the list of identifiers in the received heartbeat message.

Condition 2: The TC node 200a fails to receive the heartbeat message from the RA node 300 whilst the counter condition is satisfied.

Examples of different counter conditions will be disclosed below.

In some aspects, an explicit check is made whether any of condition 1 or condition 2 is fulfilled. Hence, in some embodiments, the TC node 200a is configured to perform (optional) steps S104a and S104b.

S104a: The TC node 200a checks if condition 1 is fulfilled. If so, step S106a is entered. Else step S104b is entered.

S104b: The TC node 200a checks if instead condition 2 is fulfilled. If so, step S106b is entered. Else no self-revocation is performed and the TC node 200a can wait for reception of a next heartbeat message, possibly first entering (optional) step S102 which will be disclosed below.

Hence, the TC node 200a performs self-revocation when either its identifier is included in the list received from the RA node 300, or if the heartbeat message is not received whilst the counter condition is still satisfied.

Embodiments relating to further details of self-revocation as performed by the TC node 200a will now be disclosed.

In general terms, the DAA credentials enable the TC node 200a to send authenticated messages towards other TC nodes 200b.

In some examples, the identifier is a pseudonym.

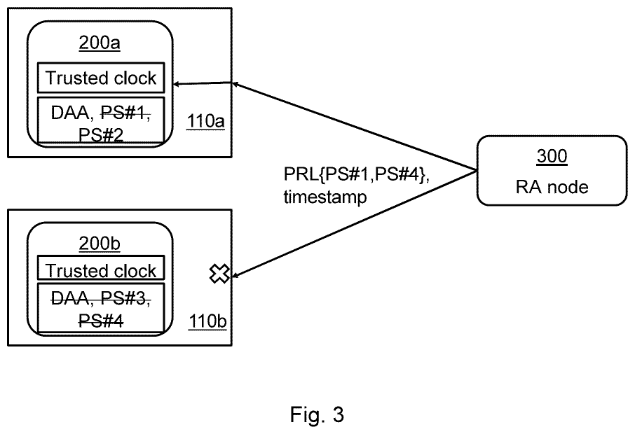

Parallel reference is next made to FIG. 3 which schematically illustrates a first vehicle 110a in which TC node 200a is placed and a second vehicle 110b in which TC node 200b is placed. In FIG. 3 is also shown the RA node 300. In FIG. 3 is assumed for illustrative purposes that the second vehicle 110b is compromised but that TC node 200b is operating according to embodiments disclosed herein.

It is further assumed that TC node 200a and TC node 200b each is provided with a trusted clock that is, up to a time difference TDiff, synchronized with a clock of the RA node 300. A positive value of TDiff means that the clock of the TC node in question is behind the clock of the RA node 300. This notation will be used later when discussing the value of T (defined as the worst-case revocation time).

The RA node 300 broadcasts the same heartbeat message to both vehicles 110a, 110b. Hence, in some embodiments, the heartbeat message is a periodically broadcast heartbeat message. The heartbeat message comprises a digitally signed revocation request (PRL; pending revocation list) with a list of identifiers for which revocation is pending and a digitally signed timestamp. Hence, in some embodiments, the freshness parameter is a timestamp. In this example, the list contains identifiers PS #1 and PS #4, which means that these two identifiers are about to be revoked.

In normal operation (as represented by vehicle 110a), the vehicle 110a forwards the heartbeat to its TC node (as represented by TC node 200a), which first verifies the signature of the heartbeat message, and then checks its freshness using the timestamp and its internal clock. In related embodiments, correctness of the freshness parameter is verified by the TC node 200a comparing the timestamp to an internal clock source in the TC node 200a and verifying that the timestamp is not older than a threshold time duration value. If the timestamp in the heartbeat message is older than a value TV (representing the validity period of a heartbeat message) since the current time, the heartbeat message is not accepted and therefore discarded. Hence, in some embodiments, the counter condition is specified by a fixed amount of time, and the counter condition is satisfied as long as the fixed amount of time since receiving a most recent heartbeat message from the RA node 300 has not elapsed.

After ensuring that the heartbeat message is fresh, TC node 200a inspects the list; if it contains one of the vehicle's pseudonyms (PS #1 in the present case), the TC node 200a proceeds with the deletion of all the data related to it. Finally, the TC node 200a updates its “auto-revocation” timeout, which is a security technique where the TC node automatically unsubscribes from the network if heartbeats are not received for a time TR (as described below).

In case of compromise (as represented by vehicle 110b), the malicious vehicle wants to avoid revocation of PS #4, and hence the vehicle 110b drops the heartbeat message before it reaches its TC node (as represented by TC node 200b). According to normal self-revocation operation, TC node 200b would thus never receive the heartbeat message and therefore PS #4 would not be revoked. However, absence of reception of any heartbeat message implies that the auto-revocation timeout will not be reset. Therefore, after some time TR since the last valid heartbeat message was processed by TC node 200b, auto-revocation logic is executed and TC node 200b removes itself from the DAA network by deleting all pseudonyms and credentials. In other words, TC node 200b fails to receive the heartbeat message from the RA node 300 whilst the counter condition is satisfied.

Therefore, even in case of compromise, the revocation would still occur within a fixed time T, which is a parameter that depends on TR, TV, and TDiff. An approximation of the value of T in the worst-case scenario will be disclosed below.

A revocation confirmation message may be sent from each TC node 200a, 200b to the RA node 300 to conform that the revocation has succeeded. However, such a revocation confirmation message is optional. In this respect, to ensure that the list of identifiers for which revocation is pending does not continuously grow longer and longer over time, an identifier can be removed from the list if any of the following conditions is met: (i) the TC node 200a sends a revocation confirmation, or (ii) a time period T has passed, after which the self-revocation process should have completed.

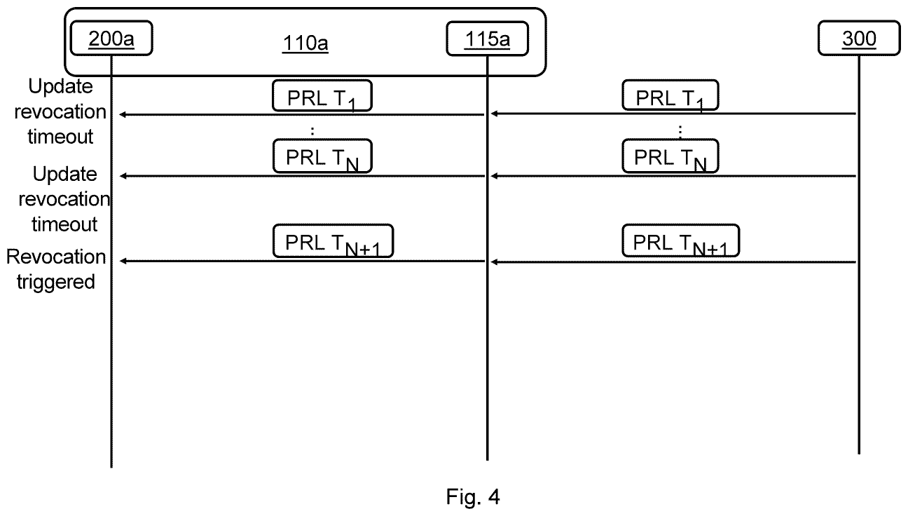

Reference is next made to the sequence diagram of FIG. 4 which shows how the example illustrated with reference to FIG. 3 works under normal operation (i.e., the TC node being provided in a benign, or uncompromised, vehicle). The RA node 300 broadcasts heartbeat messages (comprising one digitally signed revocation request PRL per each heartbeat message as sent at times with index 1, N and N+1) which are received by a host 115 in the vehicle 110a and forwarded directly to the TC node 200a. If the list of identifiers for which revocation is pending does not contain any of the identifiers of the vehicle, the TC node upon reception of a heartbeat message just resets its internal timer and continues its operation regularly. Otherwise, the TC node proceeds with the self-revocation process.

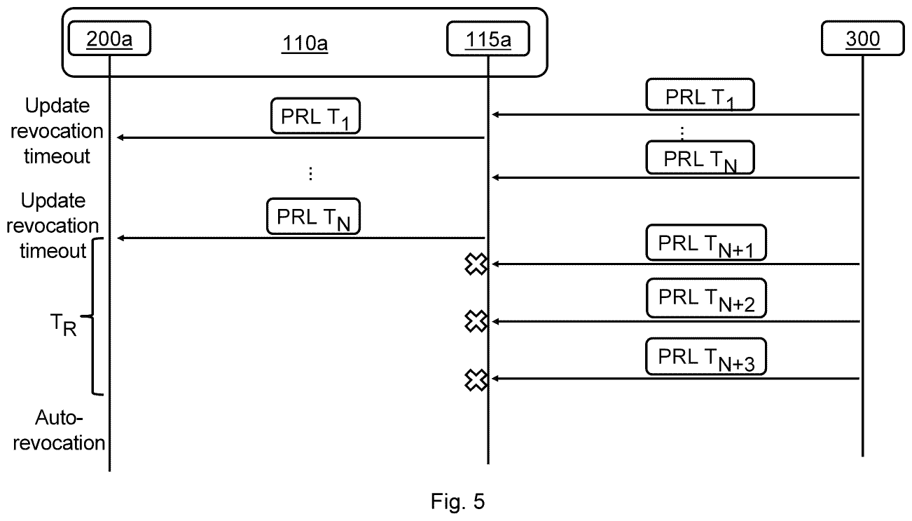

Reference is next made to the sequence diagram of FIG. 5 which shows how the example illustrated with reference to FIG. 3 works during a possible attack scenario. The symbol “x” denotes that a message is blocked by the host 115a in the vehicle 110a (either from being forwarded to the TC node 200a, or from being forwarded to the RA node 300). The RA node 300 broadcasts heartbeat messages (comprising one digitally signed revocation request PRL per each heartbeat message as sent at times with index 1, N, N+1, N+2, and N+3). Here the TC node is provided in a malicious, or compromised, vehicle which not only wants to block any revocation requests (such as the signed revocation request PRL at times with index N+1, N+2, and N+3), but also wants to delay heartbeat messages as much as possible so that the TC node will remain operational for as long as possible. However, since the heartbeat message contains a timestamp, this delay cannot be arbitrarily long. If an attacker delays any heartbeat message for too long, the timestamp check as performed by the TC node will reveal that the heartbeat message is older than the validity time TV, and the TC node would not accept the heartbeat message as valid. After the revocation is issued, a malicious, or compromised, vehicle would stop forwarding heartbeat messages to its TC node. Thus, the TC would trigger self-revocation after a time TR since the last valid heartbeat message received.

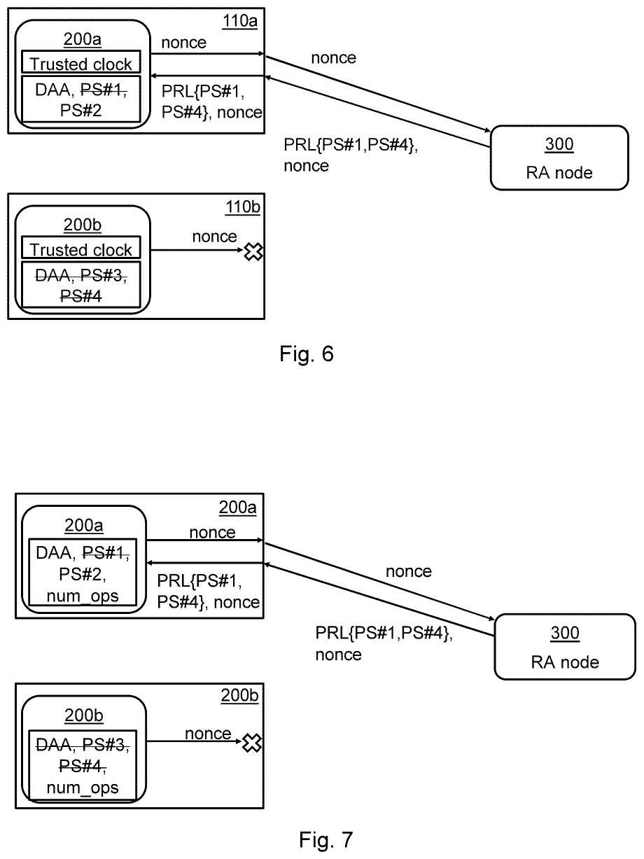

Parallel reference is next made to FIG. 6 and FIG. 7 which schematically illustrates a first vehicle 110a in which TC node 200a is placed and a second vehicle 110b in which TC node 200b is placed. In FIG. 6 and FIG. 7 is also shown the RA node 300. In FIG. 6 and FIG. 7 is assumed for illustrative purposes that the second vehicle 110b is compromised but that TC node 200b is operating according to embodiments disclosed herein. Also this example, the list of identifiers for which revocation is pending contains identifiers PS #1 and PS #4, which means that these two identifiers are about to be revoked.

Common for the examples in FIG. 6 and FIG. 7 is that the RA node 300 does not periodically broadcast any heartbeat messages as in FIG. 3, but rather the RA node 300 responds to requests sent by at least one of the TC nodes 200a, 200b. Hence, in some embodiments, the TC node 200a is configured to perform (optional) step S102.

S102: The TC node 200a sends a request message towards the RA node 300 for the list of identifiers for which revocation is pending. The request message comprises the freshness parameter. The heartbeat message is by the TC node 200a then expected to be received from the RA node 300 in response thereto, i.e., in response to the TC node 200a having sent the request message.

Essentially, the TC node 200a generates a fresh nonce that is attached (and, optionally, also digitally signed) to the request sent to the RA node 300. The same nonce, as signed by the RA node 300 is then included in the heartbeat message together with the signed list of identifiers for which revocation is pending. Hence, in some embodiments, the freshness parameter is a nonce. Additionally, since synchronized time information in real-time might not be available for all TC nodes in this scenario, the validity time of messages sent between the TC nodes 200a:200d might be controlled by unforgeable epoch markers distributed to the TC nodes 200a:200d in the heartbeat messages sent from the RA node 300.

After that, the TC node receives the response (i.e., the revocation request PRL and the nonce), checks that the attached nonce is the same used in the request, and then inspects the list in the same manner as disclosed above. Hence, in some embodiments, the correctness of the freshness parameter is verified by the TC node 200a comparing the nonce received in the heartbeat message to the nonce sent in the request message and verifying that the nonce received in the heartbeat message corresponds to the nonce sent in the request message. Moreover, the TC node 200a might store the unforgeable epoch marker for use in sending and receiving messages to/from other TC nodes 200b:200d. When the TC node 200a receives a message from another TC node 200b:200d, the TC node 200a can use the epoch marker to check that the message was generated recently. Conversely, when sending a message towards another TC node 200b:200d, the TC node 200a might attach the epoch marker to prove the same to the receiving TC node 200b:200d. It is here emphasized that, as disclosed above, the epoch markers are distributed to the TC nodes 200a:200d in heartbeat messages sent from the RA node 300. Hence, an epoch marker received from another entity (such as from another TC node 200a:200d) will not be stored (or attached to a message sent by the TC node 200a). However, an epoch marker received in a message received from another TC node might by the receiving TC node trigger auto-revocation in the same manner as epoch markers received from the RA node 300.

In case of compromise, either a request message may never reach the RA node (as for the request message sent by TC node 200b) or the response may be dropped by the vehicle before reaching the TC node. The two examples illustrated in FIG. 6 and FIG. 7 deal with this issue in two different ways.

In the example of FIG. 6 a trusted internal clock is used by the TC nodes 200a, 200b to measure the elapsed time since the last valid heartbeat message was received.

When the auto-revocation timeout expires (after a time TR), the revocation process is triggered automatically as in the example illustrated in FIG. 3.

The example illustrated in FIG. 7, however, does not rely on the use of trusted internal clocks. Instead of measuring the time, the TC nodes 200a, 200b measure the number of operations (i.e., signing messages to be transmitted, receiving new messages, etc.) performed using a counter stored in secure memory (referred to as num_ops in FIG. 7). Hence, in some embodiments, the counter condition is specified by a fixed number of operations, and the counter condition is satisfied as long as the TC node 200a has performed less number of operations than the fixed number of operations M since receiving a most recent heartbeat message from the RA node 300. After M operations, the revocation process is triggered automatically. The counter is reset every time a valid heartbeat message is received.

Moreover, the revocation process might be triggered if a heartbeat message, or a message sent by another TC node, is received that contains an epoch marker that reveals that the TC node 200a have missed reception of too many heartbeat messages, as indicated by the last epoch marker received. That is, in some embodiments, the heartbeat messages comprise epoch markers, the counter condition is specified in terms of epochs, and the counter condition is satisfied as long as a difference between the epoch markers in two adjacently received heartbeat messages is less than a predetermined amount of epochs. In particular, this can be determined when more than a predetermined number of ET epochs have passed since the last received epoch marker, judging by the most recently received epoch marker. For such use the epoch markers should contain information, such as sequence numbers, that allow the TC node 200a to infer how many epoch changes the TC node 200a might have missed.

For the example in FIG. 7 the worst-case revocation time T is then equal to ET+2 epoch durations. However, it is noted that auto-revocation is not necessarily triggered at all during, or after, this time. If the limit M has not been reached, the TC node 200a might comply to requests to sign new messages that are to be sent towards other TC nodes 200b:200d, even after the time T. Nevertheless, as the attached epoch marker would point to an old epoch, the validity time for such messages would have expired and no other TC node 200b:200d that is correctly synchronized to the current epoch would accept such a message. Hence, revocation is effectively achieved as the vehicle of any revoked TC node cannot send valid messages anymore to other participating vehicles that are in synchronization with the current epoch. If the vehicle of any revoked TC node tries to update the epoch marker stored in the TC node by receiving a heartbeat message, auto-revocation of its identifiers would occur after processing the pending revocation list. After the time T=ET+2 epoch durations has passed, the RA node 300 can remove the revoked identifiers from the list. Any subsequent attempt by the vehicle of the revoked TC node to update the epoch marker by receiving a heartbeat message would result in revocation as well, as the number of missed epoch markers would exceed the value ET.

Further in this respect, the parameter ET might be regarded as providing a tolerance value, measured in epochs. Thus, ET=0 implies no tolerance. For messages sent between the TC nodes 200a:200d, having ET=0 implies that a TC node only will process messages produced during the current epoch. Likewise, for the heartbeat messages sent by the RA node 300, having ET=0 implies that the TC nodes would only allow an incremental epoch change, i.e., that the TC nodes would not be allowed to miss any change of epoch. For example, the counter condition would be considered fulfilled if the most recently received epoch marker from the RA node 300 as sent in a heartbeat message was for epoch “k” and the next received epoch marker from the RA node 300 as sent in a heartbeat message was for epoch “k+1” (assuming that epoch “k+1” follows immediately after epoch “k”). But if instead the next received epoch marker from the RA node 300 as sent in a heartbeat message was for epoch “k+2” the counter condition would no longer be considered fulfilled. On the other hand, ET>0 allows for some tolerance. For example, ET=1 implies that a TC node would accept as valid any messages received from another TC node produced during the current epoch or the previous epoch. Hence, the TC node would trigger auto-revocation if, when receiving a heartbeat message, the difference between the epoch marker included in the heartbeat message and the current epoch marker stored in the TC node is greater than ET+1.

Considering the definitions above, the following worst-case scenario apply for the example in FIG. 7. Assume that revocation for TC node 200a is by the RA node 300 issued during the epoch with index I, denoted E_i. Then, epoch E_i will also be the last epoch processed by the TC node 200a to be revoked. In other words, the value of latest received and stored epoch marker, denoted E_stored, for the TC node 200a to be revoked cannot be greater than E_i. Further, for reasons disclosed above, any TC node 200b:200d for which E_stored≥E_i+ET+1 will discard messages sent from TC node 200a. Consequently, starting from epoch E_i+ET+2, the revoked identifier (of TC node 200a) can be safely removed from the list of identifiers for which revocation is pending. This is true since, for reasons disclosed above, any new heartbeat message processed by the TC node 200a would cause auto-revocation.

An identifier could also be removed from the list of identifiers for which revocation is pending after the maximum validity time of the identifiers have expired. The latter thus requires that the identifiers as such have a limited time span and that the RA node is aware of the point in time when the identifiers were generated.

The examples in FIG. 6 and FIG. 7 allows the RA node 300 to produce a different response to each TC node 200a, 200b; for example, the RA node 300 could respond with a subset of the list of identifiers for which revocation is pending that would include only the identifiers owned by that particular TC node 200a, 200b. This would reduce the data sent and hence reduce network traffic and alleviate the computation load in the TC node.

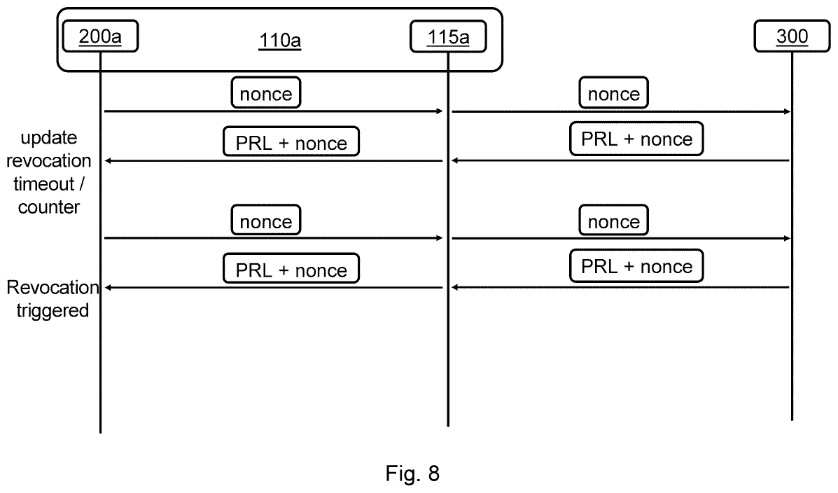

Reference is next made to the sequence diagram of FIG. 8 which shows how the examples illustrated with reference to FIG. 6 and FIG. 7 work under normal operation (i.e., the TC node being provided in a benign, or uncompromised, vehicle). The TC node first generates (and stores into its internal memory) a nonce that is forwarded to the RA node through the vehicle. The RA node then sends a response (PRL+nonce) in a heartbeat message towards the TC node. The TC node uses the stored nonce to verify the freshness of the received heartbeat message. Again, if the list of identifiers for which revocation is pending does not contain any of the identifiers of the vehicle, the TC node upon reception of a heartbeat message just resets its internal timer (or counter, depending on the variant used) and continues its operation regularly. Otherwise, the TC node proceeds with the self-revocation process. In FIG. 8 this procedure is repeated twice.

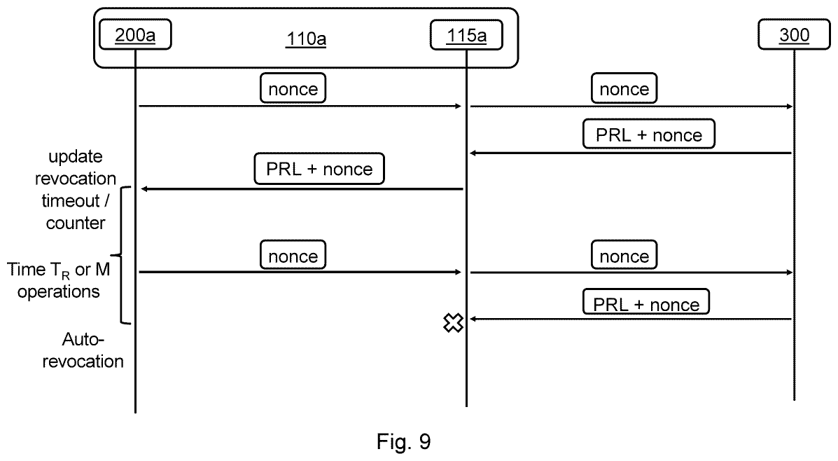

Reference is next made to the sequence diagram of FIG. 9 which shows how the examples illustrated with reference to FIG. 6 and FIG. 7 work during a possible attack scenario. Here the TC node 200a is provided in a malicious, or compromised, vehicle 110a which not only wants to block any revocation requests PRL, but also wants to delay heartbeat messages as much as possible so that the TC node will remain operational for as long as possible. Again, an attacker delays any heartbeat message for too long, self-revocation would be triggered automatically after a time TR (or M operations, depending on the variant used) since the last valid heartbeat message received. In FIG. 9 the first nonce as sent by the TC node 200a is received by the RA node 300, the response (PRL+nonce) to this first nonce is received by the TC node 200a, but the second response (PRL+nonce) as sent by the RA node 300 in response to the second nonce sent by the TC node 200a is not received by the TC node 200a.

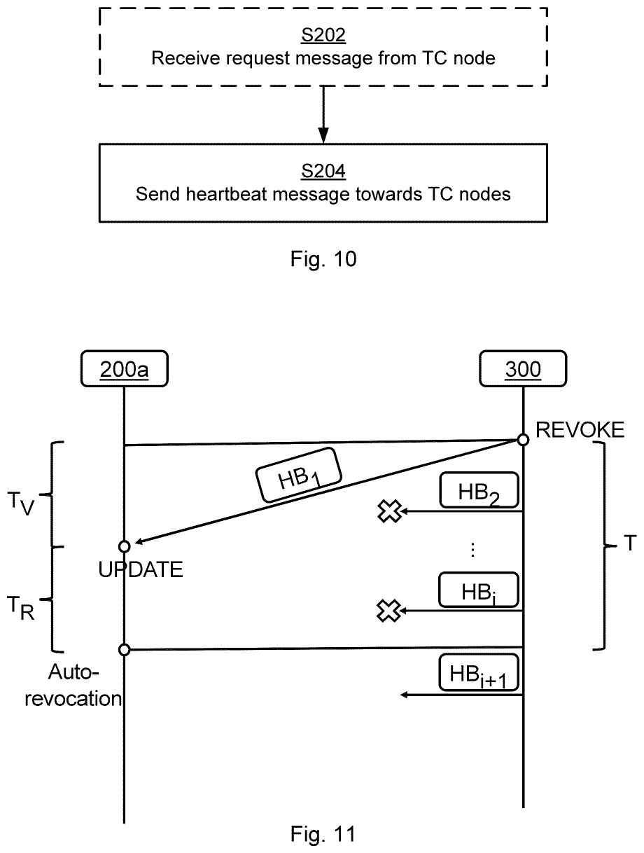

Reference is now made to FIG. 10 illustrating a method for sending a heartbeat message for self-revocation as performed by the RA node 300 according to an embodiment.

S204: The RA node 300 sends a heartbeat message towards TC nodes 200a, 200b. The heartbeat message comprises a freshness parameter and a revocation request with a list of identifiers of TC nodes 200a, 200b for which revocation is pending. The revocation pertains to revocation of identifiers for which the revocation is pending.

Hence, the heartbeat message comprises both a freshness parameter and revocation request.

Embodiments relating to further details of sending a heartbeat message for self-revocation as performed by the RA node 300 will now be disclosed.

In general terms, the same aspects, embodiments, and examples as disclosed above with reference to the methods performed by the TC node 200a apply equally to the methods performed by the RA node 300.

In particular, as disclosed above, in some embodiments, the identifiers are pseudonyms.

In particular, as disclosed above, in some embodiments, the heartbeat message is sent before a timer expires.

In particular, as disclosed above, in some embodiments, the heartbeat message is a periodically broadcast heartbeat message.

In particular, as disclosed above, in some embodiments, the duration of the timer corresponds to periodicity of the periodically broadcast heartbeat message.

In particular, as disclosed above, in some embodiments the freshness parameter is a timestamp and in other embodiments the freshness parameter is a nonce.

In particular, as disclosed above, in some embodiments the heartbeat message is (expected to be) received in response to one of the TC nodes 200a:200d having sent a request message. Hence, in some embodiments, the RA node 300 is configured to perform (optional) step S202.

S202: The RA node 300 receives a request message from one of the TC nodes 200a, 200b for the list of identifiers for which revocation is pending. The request message comprises the freshness parameter. The heartbeat message is sent from the RA node 300 in response thereto. That is, the reception of the request message in step S202 triggers the RA node 300 to send the heartbeat message in step S204.

In particular, as disclosed above, in some embodiments the duration of the timer corresponds to a maximum allowed time duration between receiving the request message and sending the heartbeat message.

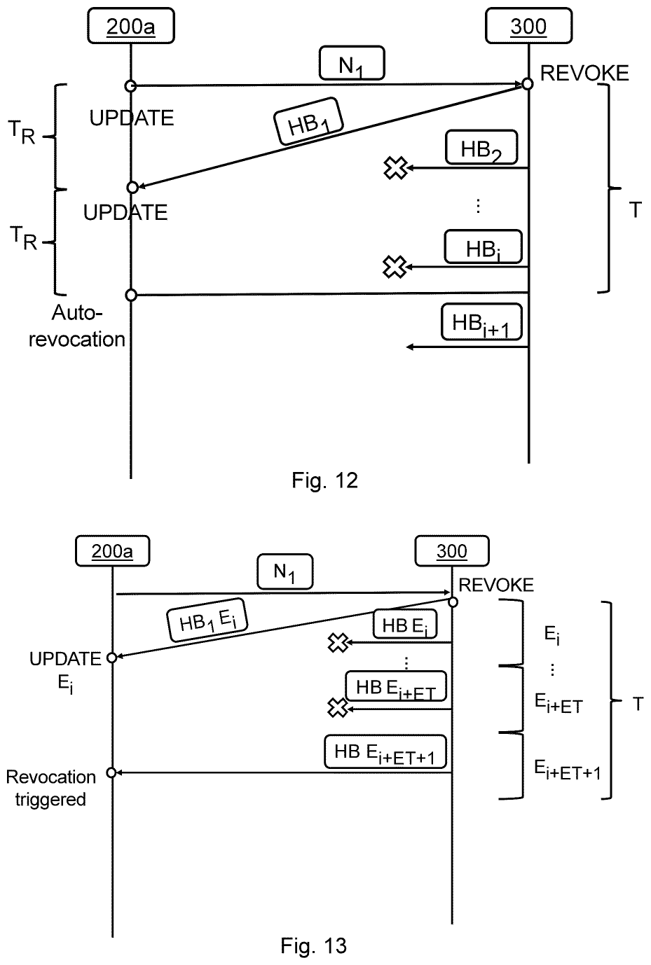

As disclosed above, the value of T is defined as the worst-case revocation time. Further aspects of how the value of T can be estimated for the different examples disclosed above will be given next in conjunction with reference to FIG. 11 and FIG. 12. In these figures the revocation is delayed as much as possible (e.g., due to an attack or simply network delays, or other factors). FIG. 11 corresponds to the example in FIG. 3.

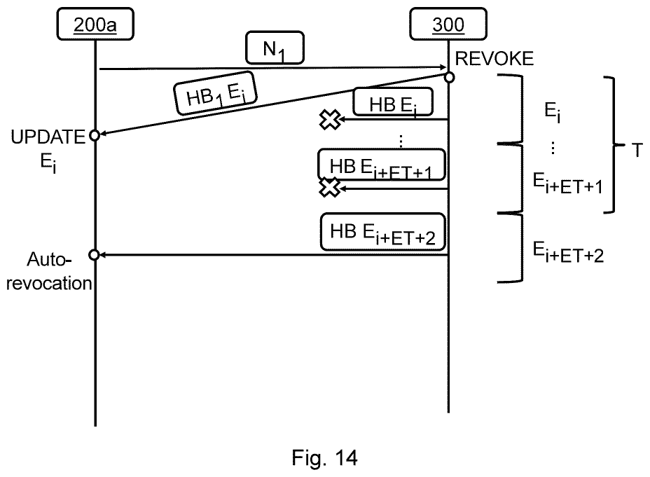

FIG. 12 corresponds to the example in FIG. 6. FIG. 13 and FIG. 14 correspond to the example in FIG. 7.

Revoking an identifier (as indicated by REVOKE in FIG. 11, FIG. 12, FIG. 13, and FIG. 14) means that the identifier is added it to the list of identifiers for which revocation is pending. Subsequent heartbeat (HB) messages (denoted HB 1, HB 2, HB i, and HB i+1 in FIG. 11 and in FIG. 12, and denoted HB1 Ei, HB Ei, HB Ei+ET, and HB Ei+ET+1 in FIG. 13 and in FIG. 14, where Ei, Ei+ET, and Ei+ET+1 are three epochs) would then contain the identifier and would trigger revocation on the affected TC node. A worst-case revocation time T is the minimum amount of time an identifier must remain in the list of identifiers for which revocation is pending to ensure that any attacker cannot bypass the revocation. For the example in FIG. 7, the worst-case revocation time T is equal to T=ET+2 epoch durations. However, even after that time, old messages of any revoked TC node might still be processed by other TC nodes if such other TC nodes are not perfectly synchronized. For the example in FIG. 6, with the correct value of T it can be ensured that after the timer period T the RA node 300 can be confident that either a heartbeat message has been received by the TC node, or the TC node has performed auto-revocation.

Recall that, after processing a heartbeat message each TC node 200a, 200b updates its auto-revocation timeout (as indicated by UPDATE in FIG. 11 and FIG. 12 and UPDATE Eᵢ in FIG. 13 and FIG. 14). The auto-revocation timeout in FIG. 11 and FIG. 12 is set to a value TR. Further, in in FIG. 12, FIG. 13, and FIG. 14 the first heartbeat message is sent in response to the TC node 200a having sent a nonce N1.

For ease of description, but without loss of generality, transmission and processing times are not included in the calculations, as the transmission and processing times are unpredictable and highly variable. However, this is not a security concern, as the value of T would be overapproximated, which only means that an identifier would remain in the list of identifiers for which revocation is pending a bit longer than needed.

It is noted that it cannot be guaranteed that a TC node would revoke itself within the time T. For example, if the execution of a TC node was suspended at some point in time, the revocation procedure would not be executed until the TC node is re-scheduled again. However, this is not an issue as the TC node would revoke itself as soon as its execution resumes (due to the expiration of the auto-revocation timeout). The value of T only indicates the minimum amount of time an identifier must remain in the list of identifiers for which revocation is pending to ensure that revocation cannot be bypassed.

With reference now to FIG. 11, it is recalled that for the example in FIG. 3 the RA node 300 periodically and regularly broadcasts heartbeat messages. Each heartbeat message includes a timestamp that is used by a TC node to ensure the freshness of the heartbeat message. If the heartbeat message is older than a time TV, the heartbeat message is discarded.

The worst-case situation corresponds to that a heartbeat message (denoted HB1 in FIG. 11) is broadcast an instant before the revocation (REVOKE) occurs. This would be the last heartbeat message processed by the TC nodes, as an attacker would drop all the subsequent heartbeat messages since they would include the undesired revocation information (as provided in heartbeat messages HB2, . . . , HBi).

An attacker would delay the heartbeat message HB1 for as long as possible before reaching the TC node. In the worst case, the heartbeat message HB1 is delayed by a time TV (after which it would not be processed by the TC node, and self-revocation would occur eventually). It is here noted that since the timestamp included in HB1 is relative to the internal clock of the RA node 300, but the freshness check is performed by the TC node, the value of TDiff must be considered. If the internal clock of the TC node is behind the internal clock of the RA node, i.e., TDiff>0, the heartbeat message would remain valid for longer time, and the opposite would occur otherwise.

After processing the heartbeat message HB1, each TC node updates its auto-revocation timeout (as indicated by UPDATE in FIG. 11). From now on, any attacker would continue to drop heartbeat messages HB2, . . . , HBi, but eventually (after the time duration TR) self-revocation would be triggered automatically. After that, the identifier could be safely removed from the list of identifiers for which revocation is pending.

To summarize, the worst-case revocation time for the example in FIG. 3 can be computed as T=TV+TR+TDiff. Hence, in some embodiments, any identifiers specified in the list of identifiers are kept in the list at least an amount of time T equal to T=TV+TR+TDiff, where TV is validity period of the heartbeat message, TR is duration of a timer started when a most recently sent heartbeat message is processed by the TC nodes 200a, 200b, and TDiff is time difference between an internal clock source in one of the TC nodes 200a, 200b and an internal clock source in the RA node 300.

With reference now to FIG. 12, it is recalled that for the example in FIG. 6 that the TC node sends a nonce to the RA node 300, and the RA node 300 replies with the same nonce and the list of identifiers for which revocation is pending. The nonce is used to ensure freshness, preventing the TC node from processing old heartbeat messages. In this way, the self-revocation timeout would ensure that a heartbeat message is not delayed for an arbitrary amount of time.

Again, the worst-case scenario is when a heartbeat message (as represented by HB1 in FIG. 12) is produced an instant before the REVOKE. Since the heartbeat message HB1 would not contain the revocation information, any attacker could correctly deliver it to the TC node. The heartbeat message HB1 is the response to a request that contains the nonce N1. For the same reasons as above, transmission times and other delays are ignored, and it is assumed that the request is generated at the same time as the response.

The heartbeat message HB1 can be delayed up until the self-revocation timeout of the TC node expires. This depends on when the previous heartbeat message was processed (as illustrated by the first UPDATE in FIG. 12); the later the previous heartbeat message was processed, the longer the TC node remains operational, and the longer the heartbeat message HB1 can be delayed. However, the first UPDATE cannot occur after the generation of the nonce N1, because after that moment the TC node would discard all heartbeat messages containing nonces different from N1 (to avoid replay attacks). Therefore, the first UPDATE would occur at the same time as the generation of the nonce N1 in the worst case, which also corresponds to the REVOKE time (as discussed before).

As a consequence, the heartbeat message HB1 would be processed at most after the time TR has elapsed since the first REVOKE. The second UPDATE would occur, and the self-revocation timeout would be updated to the current time plus the value TR. After that time, the identifier could be safely removed from the list of identifiers for which revocation is pending.

To summarize, the worst-case revocation time for the example in FIG. 6 can be computed as T=2·TR. Hence, in some embodiments, any identifiers specified in the list of identifiers are kept in the list at least an amount of time T equal to T=2·TR, where TR is duration of a timer started when a most recently sent heartbeat message is processed by the TC nodes 200a, 200b.

With reference now to FIG. 13, and FIG. 14, it is recalled that according to the above description of FIG. 7, the worst-case revocation time for the example in FIG. 7 can be computed as T=(ET+2)·ED, where ED is the duration of one epoch. The value of T can be interpreted as the time after which the identifier can be safely removed from the list of identifiers for which revocation is pending. Hence, in some embodiments, any identifiers specified in the list of identifiers are kept in the list at least an amount of time T equal to T=(ET+2)·ED, where ED is duration of one epoch and ET is a tolerance value, given in terms of epochs. However, the value of T also provides some guarantee about the revocation time, at least for all the TC nodes 200b:200d that have received the latest epoch marker; these TC nodes 200b:200d will discard any messages sent by the thus revoked TC node 200a. For any TC node that has not received the latest epoch marker, any such TC node will discard any messages sent by the thus revoked TC node 200a only after the worst-case message validity time (WVT) after the revocation of the TC node 200a was issued by the RA node 300.

The different types of worst cases are summarized in Table 1.

TABLE 1
Summary of worst cases, where: TR = revocation timer, TV = heartbeat
validity time, Tdiff = maximum synchronization time difference, mVT =
maximal message validity time, ET = Epoch tolerance, and ED = epoch duration.

| Property | Example in FIG. 3 | Example in FIG. 6 | Example in FIG. 7 |
|---|---|---|---|
| Worst case self- | TR + TV + Tdiff | 2 · TR | (ET + 2) · ED |
| revocation time | | | |
| (time in PRL) (T) | | | |
| Worst case | Any TC request | Any TC request | 1. More than 2 · M − 2 |
| Auto-Revocation | after T | after T | TC requests after |
| cause | | | revocation |
| | | | 2. Receiving |
| | | | heartbeat after T |
| | | | 3. Receiving any |
| | | | message with |
| | | | epoch marker |
| | | | more than ET |
| | | | newer |
| Worst case V2V | Timestamp: | Epoch marker: | Epoch marker: |
| freshness | T after revocation | Epoch of | Epoch of |
| parameter (WVF) | | revocation | revocation |
| mVT for correctly | Arbitrarily chosen | (ET + 1) · ED | (ET + 1) · ED |
| synchronized TC | time plus Tdiff | | |
| nodes | | | |
| Worst case | T + mVT | mVT + min{T, | T + ET · ED |
| message validity | | (ET + 1) · ED} | |
| time (WVT) after | | | |
| revocation | | | |

With further reference to Table 1, the worst-case self-revocation time T describes the (maximum length) of the period of self-revocation, during which the identifier of a TC node has to stay on the list (i.e., the PRL) of identifiers for which revocation is pending for self-revocation of that identifier to be triggered upon the TC node receiving a heartbeat message from the RA node 300. After that period an indefinite auto-revocation period begins during which certain operations performed by TC node may result in auto-revocation. The minimal requirements for this to occur are in Table 1 listed as worst case auto-revocation causes. As described above, a given TC node may still send messages signed with an identifier to other TC nodes after an identifier of the given TC node has been entered into the PRL. The worst-case freshness parameter (WVF) for messages sent between the vehicles describes the latest possible freshness parameter that could be used by the given TC node after the time of revocation, without risking self- or auto-revocation. A message sent by one TC node may be accepted as valid by correctly synchronized TC nodes for the maximum message validity time (mVT). However, some TC nodes might not be perfectly synchronized. The worst-case message validity time after revocation (WVT) gives a limit for how much time after revocation (i.e., when an identifier is entered into the PRL), any message generated based the thus revoked credentials may still be accepted by another TC node that is still synchronized with the RA node and the rest of the TC nodes and within some tolerances. After this time the identifier can be regarded as effectively revoked as the identifier will not be accepted by the other TC nodes. With reference to the Worst case Auto-Revocation cause for the example in FIG. 7, namely more than 2·M−2 TC requests after revocation, this is because revocation occurs due to, or after, the M:th request from the TC node after the last valid heartbeat message was received. Therefore, at most M−1 requests can be made after a valid heartbeat message. The worst case revocation cause would therefore be more than 2·(M−1)=2·M−2 requests.

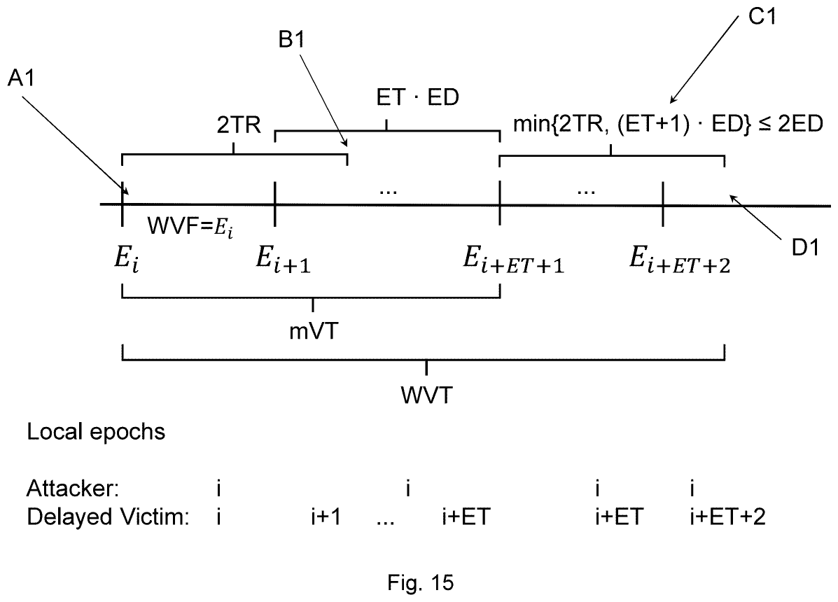

In FIG. 15 is provided a first illustrative example, corresponding to the example in FIG. 6 where TR≤ED, of behavior of a malicious vehicle acting as an attacker and a normally behaving vehicle acting as a victim. At A1 is marked the earliest possible revocation in the epoch E with index i. At B1 is marked the last possible epoch (i.e., the epoch E with index i+1) in which the epoch marker for the attacker can be refreshed. This is also the epoch in which the auto-revocation period starts. At C1 is marked the period during which any message received by the victim from the attacker after the victim has updated its epoch will be discarded. At D1 is marked the point in time after which, if the victim is delayed even further, any message received from any other TC node (except the attacker) that is still synchronized with the system will trigger auto-revocation for the victim due to the timer expiring or due to too many epoch markers being missed.

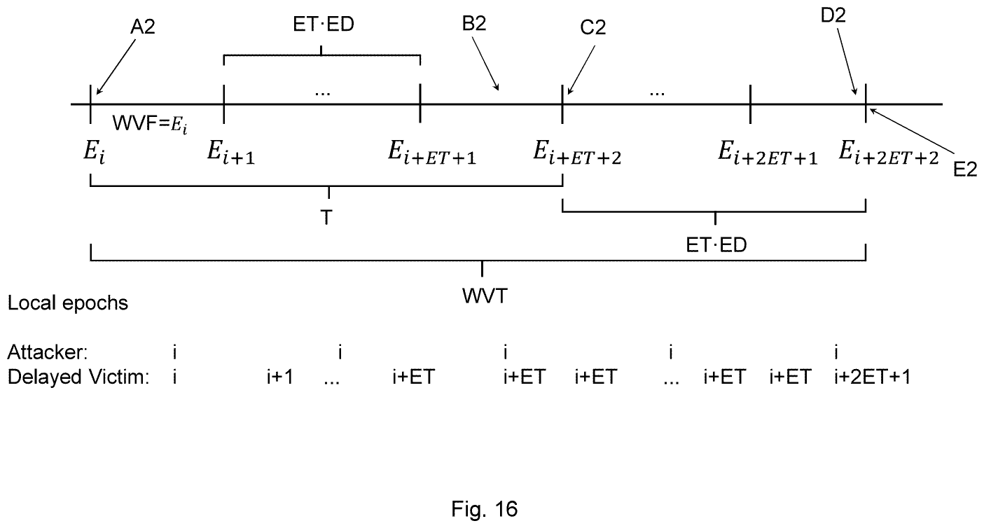

In FIG. 16 is provided a second illustrative example, corresponding to the example in FIG. 7, of behavior of a malicious vehicle acting as an attacker and a normally behaving vehicle acting as a victim. At A2 is marked the earliest possible revocation in the epoch E with index i. At B2 is marked the last possible epoch (i.e., the epoch E with index i+ET+1) in which the epoch marker for the attacker can be refreshed. At C2 is marked the epoch E with index i+ET+2 in which the auto-revocation period starts. At D2 is marked the end of the epoch E with index i+2·ET+1; any message received by the victim from the attacker after the victim has updates its epoch will be discarded. At E2 is marked the start of the epoch with index i+2·ET+2; if the victim is delayed even further, any message received from any other TC node (except the attacker) that is still synchronized with the system after this point in time will trigger heartbeat lookup and auto-revocation.

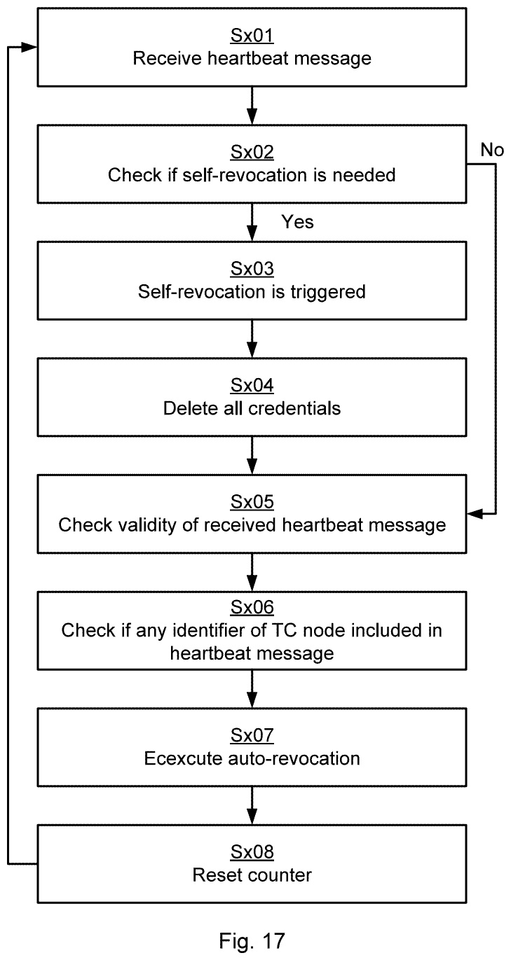

Reference is next made to the flowchart of FIG. 17 which shows logic executed by the TC node when a new heartbeat message is received. It is assumed that the TC node already is operational. Depending on the variant used, the TC node when processing a heartbeat message might compute a new auto-revocation timeout using the formula: timeout=time_now+TR, where time_now specifies the current point in time (step Sx01). This value would be temporarily stored into local memory of the TC node. The new timeout is calculated immediately, to avoid classic Time-Of-Check-Time-Of-Use (TOCTOU) attacks; if the execution was interrupted right after the validity checks and resumed some time later, the new timeout would depend on the resume time, and this could be exploited by attackers to bypass revocation. By computing the timeout before the validity checks, instead, such attacks are prevented.

After computing the timeout, the TC node checks whether self-revocation is needed or not (step Sx02). Depending on the variant used, this check involves checking if the internal timer has reached the timeout or if the internal counter has reached a threshold value M. If so, the self-revocation process is triggered (step Sx03), and all the credentials are deleted (step Sx04). This would put the TC node in a clean state where the vehicle would need to re-join the communication network to obtain new credentials (if allowed by the issuer node).

Next, the validity of the received heartbeat message is checked (step Sx05). First, the TC node verifies the authenticity of the heartbeat message, as provided by the digital signature. Second, the TC node verifies the freshness of the heartbeat message, i.e., ensuring that the heartbeat message is not too old (e.g., because of replay or delay attacks). Depending on the variant, the freshness is either checked by checking the timestamp in the heartbeat message against the internal time source, or by checking the nonce in the message to the one attached to the request as sent by the TC node. The TC node checks (step Sx06) if any of its identifiers are included in the list of identifiers for which revocation is pending as received in the heartbeat message, and if so executes the auto-revocation for each of them (step Sx07).

Depending on the variant used, either the revocation timeout is updated using the value computed in step Sx01 or the counter is reset (step Sx08) and the execution ends.

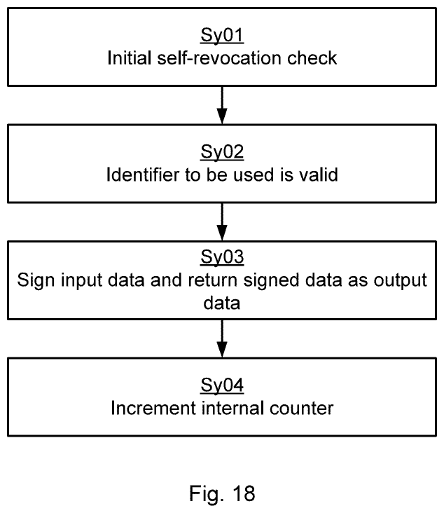

Reference is next made to the flowchart of FIG. 18 which shows logic executed by the TC node to sign a new message as generated by the vehicle in which the TC node is provided, and where this message is to be sent towards another vehicle. It is assumed that the TC node already is operational. After an initial self-revocation check (step Sy01), the TC node ensure that the identifier to be used (as requested by the vehicle) is valid (step Sy02), i.e., credentials for that identifier exist in local memory of the TC node. This check also prevents the TC node from using any revoked identifier. The TC node signs the input data, possibly includes the latest stored freshness parameter (such as either a timestamp or an epoch marker), and returns the signed data as output (step Sy03). Depending on the variant used, the TC node might increment an internal counter that counts the number of operations performed (step Sy04).

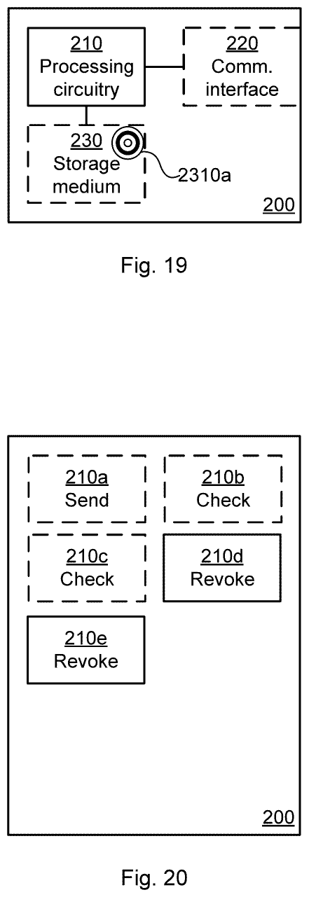

FIG. 19 schematically illustrates, in terms of a number of functional units, the components of a TC node 200a according to an embodiment. Processing circuitry 210 is provided using any combination of one or more of a suitable central processing unit (CPU), multiprocessor, microcontroller, digital signal processor (DSP), etc., capable of executing software instructions stored in a computer program product 2310a (as in FIG. 23), e.g. in the form of a storage medium 230. The processing circuitry 210 may further be provided as at least one application specific integrated circuit (ASIC), or field programmable gate array (FPGA).

Particularly, the processing circuitry 210 is configured to cause the TC node 200a to perform a set of operations, or steps, as disclosed above. For example, the storage medium 230 may store the set of operations, and the processing circuitry 210 may be configured to retrieve the set of operations from the storage medium 230 to cause the TC node 200a to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The TC node 200a may further comprise a communications interface 220 for communications with other entities, functions, nodes, and devices, such as another TC node 200b, and the RA node 300. As such the communications interface 220 may comprise one or more transmitters and receivers, comprising analogue and digital components.

The processing circuitry 210 controls the general operation of the TC node 200a e.g. by sending data and control signals to the communications interface 220 and the storage medium 230, by receiving data and reports from the communications interface 220, and by retrieving data and instructions from the storage medium 230. Other components, as well as the related functionality, of the TC node 200a are omitted in order not to obscure the concepts presented herein.

FIG. 20 schematically illustrates, in terms of a number of functional modules, the components of a TC node 200a according to an embodiment. The TC node 200a of FIG. 20 comprises a number of functional modules; a first revoke module 210d configured to perform step S106a, and a second revoke module 210e configured to perform step S106b. The TC node 200a of FIG. 20 may further comprise a number of optional functional modules, such as any of a send module 210a configured to perform step S102, a first check module 210b configured to perform step S104a, and a second check module 210c configured to perform step S104b. In general terms, each functional module 210a:210e may be implemented in hardware or in software. Preferably, one or more or all functional modules 210a:210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210e and to execute these instructions, thereby performing any steps of the TC node 200a as disclosed herein.

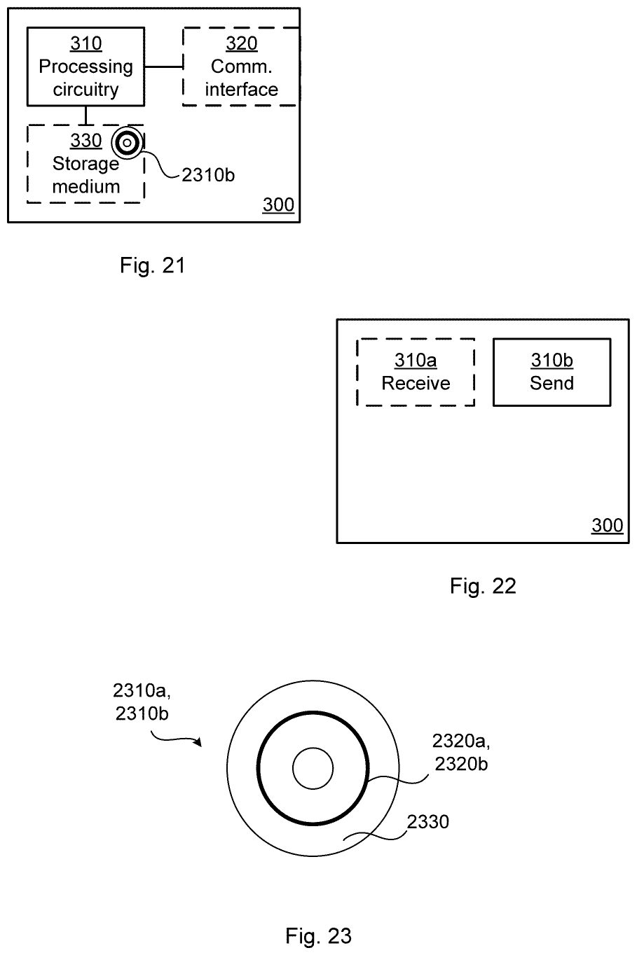

FIG. 21 schematically illustrates, in terms of a number of functional units, the components of an RA node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 2310b (as in FIG. 23), e.g. in the form of a storage medium 330. The processing circuitry 310 may further be provided as at least one application specific integrated circuit (ASIC), or field programmable gate array (FPGA).

Particularly, the processing circuitry 310 is configured to cause the RA node 300 to perform a set of operations, or steps, as disclosed above. For example, the storage medium 330 may store the set of operations, and the processing circuitry 310 may be configured to retrieve the set of operations from the storage medium 330 to cause the RA node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The RA node 300 may further comprise a communications interface 320 for communications with other entities, functions, nodes, and devices, such as the TC nodes 200a, 200b. As such the communications interface 320 may comprise one or more transmitters and receivers, comprising analogue and digital components.

The processing circuitry 310 controls the general operation of the RA node 300 e.g. by sending data and control signals to the communications interface 320 and the storage medium 330, by receiving data and reports from the communications interface 320, and by retrieving data and instructions from the storage medium 330. Other components, as well as the related functionality, of the RA node 300 are omitted in order not to obscure the concepts presented herein.

FIG. 22 schematically illustrates, in terms of a number of functional modules, the components of an RA node 300 according to an embodiment. The RA node 300 of FIG. 22 comprises a send module 310b configured to perform step S204. The RA node 300 of FIG. 22 may further comprise a number of optional functional modules, such as a receive module 310a configured to perform step S202. In general terms, each functional module 310a:310b may be implemented in hardware or in software. Preferably, one or more or all functional modules 310a:310b may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310b and to execute these instructions, thereby performing any steps of the RA node 300 as disclosed herein.

FIG. 23 shows one example of a computer program product 2310a, 2310b comprising computer readable means 2330. On this computer readable means 2330, a computer program 2320a can be stored, which computer program 2320a can cause the processing circuitry 210 and thereto operatively coupled entities and devices, such as the communications interface 220 and the storage medium 230, to execute methods according to embodiments described herein. The computer program 2320a and/or computer program product 2310a may thus provide means for performing any steps of the TC node 200a as herein disclosed. On this computer readable means 2330, a computer program 2320b can be stored, which computer program 2320b can cause the processing circuitry 310 and thereto operatively coupled entities and devices, such as the communications interface 320 and the storage medium 330, to execute methods according to embodiments described herein. The computer program 2320b and/or computer program product 2310b may thus provide means for performing any steps of the RA node 300 as herein disclosed.

In the example of FIG. 23, the computer program product 2310a, 2310b is illustrated as an optical disc, such as a CD (compact disc) or a DVD (digital versatile disc) or a Blu-Ray disc. The computer program product 2310a, 2310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 2320a, 2320b is here schematically shown as a track on the depicted optical disk, the computer program 2320a, 2320b can be stored in any way which is suitable for the computer program product 2310a, 2310b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for self-revocation, the method being performed by a trusted component, TC, node, wherein the TC node is provided with an identifier and Direct Anonymous Attestation, DAA, credentials, wherein the TC node is to receive a heartbeat message from a revocation authority, RA, node, wherein the heartbeat message comprises a freshness parameter and a revocation request with a list of identifiers for which revocation is pending, and wherein the method comprises:
revoking the DAA credentials when either:
the heartbeat message is received from the RA node whilst a counter condition is satisfied, correctness of the freshness parameter is verified by the TC node, and the identifier is present in the list of identifiers; or
failing to receive the heartbeat message from the RA node whilst the counter condition is satisfied.

2. The method according to claim 1, wherein the DAA credentials enable the TC node to send authenticated messages towards other TC nodes.

3. The method according to claim 1, wherein the identifier is a pseudonym.

4. The method according to claim 1, wherein the counter condition is specified by a fixed amount of time, and wherein the counter condition is satisfied as long as the fixed amount of time since receiving a most recent heartbeat message from the RA node has not elapsed.

5. The method according to claim 1, wherein the heartbeat message is a periodically broadcast heartbeat message.

6. The method according to claim 1, wherein the freshness parameter is a timestamp.

7. The method according to claim 6, wherein the correctness of the freshness parameter is verified by the TC node comparing the timestamp to an internal clock source in the TC node and verifying that the timestamp is not older than a threshold time duration value.

8. The method according to claim 1, wherein the method further comprises:
sending a request message towards the RA node for the list of identifiers for which revocation is pending, wherein the request message comprises the freshness parameter, and wherein the heartbeat message is expected to be received from the RA node in response thereto.

9. The method according to claim 1, wherein the freshness parameter is a nonce.

10. The method according to claim 9, wherein the correctness of the freshness parameter is verified by the TC node comparing the nonce received in the heartbeat message to the nonce sent in the request message and verifying that the nonce received in the heartbeat message corresponds to the nonce sent in the request message.

11. The method according to claim 1, wherein the counter condition is specified by a fixed number of operations, and wherein the counter condition is satisfied as long as the TC node has performed less number of operations than the fixed number of operations since receiving a most recent heartbeat message from the RA node.

12. The method according to claim 1, wherein the heartbeat message comprises an epoch marker, wherein the counter condition is specified in terms of epochs, and wherein the counter condition is satisfied as long as a difference between the epoch markers in two adjacently received heartbeat messages is less than a predetermined amount of epochs.

13. A method for sending a heartbeat message for self-revocation, the method being performed by a revocation authority, RA, node, the method comprising:
sending a heartbeat message towards trusted component, TC, nodes, wherein the heartbeat message comprises a freshness parameter and a revocation request with a list of identifiers of TC nodes for which revocation is pending, and wherein the revocation pertains to revocation of identifiers for which the revocation is pending.

14.-19. (canceled)

20. The method according to claim 13, wherein any identifiers specified in the list of identifiers are kept in the list at least an amount of time T equal to T=TV+TR+TDiff, where TV is validity period of the heartbeat message, TR is duration of a timer started when a most recently sent heartbeat message is expected to be processed by the TC nodes, and TDiff is time difference between an internal clock source in one of the TC nodes and an internal clock source in the RA node.

21. The method according to claim 13, wherein the method further comprises:
receiving a request message from one of the TC nodes for the list of identifiers for which revocation is pending, wherein the request message comprises the freshness parameter, and wherein the heartbeat message is sent from the RA node in response thereto.

22. The method according to claim 13, wherein duration of the timer corresponds to a maximum allowed time duration between receiving the request message and sending the heartbeat message.

23. The method according to claim 13, wherein the freshness parameter is a nonce.

24. The method according to claim 13, wherein any identifiers specified in the list of identifiers are kept in the list at least an amount of time T equal to T=2·TR, where TR is duration of a timer started when a most recently sent heartbeat message is expected to be processed by the TC nodes.

25. The method according to claim 13 wherein the heartbeat message comprises an epoch marker, the epoch marker marks an epoch, and wherein any identifiers specified in the list of identifiers are kept in the list at least an amount of time T equal to T=(ET+2)·ED, where ED is duration of one epoch and ET is a tolerance value, given in terms of epochs.

26. A trusted component, TC, node for self-revocation, wherein the TC node is provided with an identifier and Direct Anonymous Attestation, DAA, credentials, wherein the TC node is configured to receive a heartbeat message from a revocation authority, RA, node, wherein the heartbeat message comprises a freshness parameter and a revocation request with a list of identifiers for which revocation is pending, the TC node comprising processing circuitry, the processing circuitry being configured to cause the TC node to:
revoke the DAA credentials when either:
the heartbeat message is received from the RA node whilst a counter condition is satisfied, when correctness of the freshness parameter is verified by the TC node, and the identifier is present in the list of identifiers; or
failing to receive the heartbeat message from the RA node whilst the counter condition is satisfied.

27.-34. (canceled)
